(19) United States
(12) Patent Application Publication
(10) Pub. No.: US 2024/0328993 A1
(43) Pub. Date: Oct. 3, 2024

(54) SENSOR ELEMENT

(71) Applicant: NGK INSULATORS, LTD., Nagoya-shi (JP)

(72) Inventors: Ryo ONISHI, Iwakura-shi (JP); Hiroo MATSUSHITA, Nagoya-shi (JP)

(21) Appl. No.: 18/602,469

(22) Filed: Mar. 12, 2024

(30) Foreign Application Priority Data
Mar. 27, 2023 (JP) 2023-050553

(51) Int. Cl. G01N 27/407

(52) U.S. Cl. CPC G01N 27/4077

(57) ABSTRACT

A sensor element includes: an element body that includes a base part in an elongated plate shape, a measurement-object gas flow cavity and an extracavity electrode disposed on one principal surface; and a porous protective layer formed from one end and covering a surface of a predetermined length in the longitudinal direction of the element body. One the one principal surface, the protective layer includes an inner layer and an outer layer; and has a main region including an electrode presence region and a posterior region following to the electrode presence region; and an anterior region from the one end of the base part to the electrode presence region. A porosity in the anterior region of the inner layer is lower than that in the main region of the inner layer, and a porosity of the outer layer is lower than that in the anterior region of the inner layer.

### CROSS-REFERENCE TO RELATED APPLICATION

The present application claims priority from Japanese application JP2023-050553, filed on Mar. 27, 2023, the contents of which is hereby incorporated by reference into this application.

### BACKGROUND OF THE INVENTION

### Technical Field of the Invention

The present invention relates to a sensor element for detecting a target gas to be measured in a measurement-object gas.

### Background Art

A gas sensor is used for detection or measurement of concentration of an objective gas component (oxygen O₂, nitrogen oxide NOx, ammonia NH₃, hydrocarbon HC, carbon dioxide CO₂, etc.) in a measurement-object gas, such as exhaust gas of automobile. As such a gas sensor, a gas sensor which has a sensor element using an oxygen ion conductive solid electrolyte such as zirconia (ZrO₂) is known.

It is known that in such a gas sensor, a porous protective layer is formed on the surface of the sensor element for the purpose of preventing the occurrence of cracking in the internal structure of the sensor element due to thermal shock resulting from the attachment of moisture to the sensor element (for example, JP 2016-065852 A). That is, a sensor element provided with an element body and a porous protective layer covering the element body is known. Further, for example, JP 2014-098590 A and WO 2020/203029 A1 disclose a multi-layered protective layer, and disclose that the protective layer includes an inside layer and an outside layer having a lower porosity than that of the inside layer.

### CITATION LIST

### Patent Documents

Patent Document 1: JP 2016-065852 A
Patent Document 2: JP 2014-098590 A
Patent Document 3: WO 2020/203029 A1

### SUMMARY OF THE INVENTION

### Problems to be Solved by the Invention

The sensor element has a high temperature (e.g., about 800° C.) when the gas sensor performs measurement of a target gas to be measured. There is a problem that when moisture attaches to such a sensor element having a high temperature, cracking occurs in an internal structure of the sensor element due to the thermal shock.

In a protective layer including an inside layer (inner layer) and an outside layer (outer layer) having a lower porosity than that of the inner layer (for example, the protective layer disclosed in the above-mentioned JP 2014-098590 A and WO 2020/203029 A1), a higher porosity of the inner layer improves heat insulation performance of the protective layer. As a result, the occurrence of cracking in the internal structure of the sensor element due to exposure to water (water splash) can be better suppressed. That is, the water resistance of the sensor element can be improved. Further, by providing the outer layer having a lower porosity than the inner layer, structural strength of the protective layer as a whole can be maintained.

On the other hand, the gas sensor is required to maintain measurement accuracy in concentration of a target gas to be measured in a measurement-object gas over a long-term use.

It is therefore an object of the present invention to provide a sensor element that has high water resistance and maintains high measurement accuracy.

### Means for Solving the Problems

The present inventors have intensively studied and reach the present invention. The present invention includes the following aspects.

(1) A sensor element for detecting a target gas to be measured in a measurement-object gas, the sensor element comprising:
an element body that includes a base part in an elongated plate shape, including an oxygen-ion-conductive solid electrolyte layer, and a measurement-object gas flow cavity formed on a side of one end in a longitudinal direction of the base part; and
a porous protective layer that is formed from the one end in the longitudinal direction of the base part and covers a surface of a predetermined length in the longitudinal direction of the element body, wherein
the element body comprises: an intracavity electrode disposed in the measurement-object gas flow cavity; and an extracavity electrode that has a predetermined length in the longitudinal direction of the base part, is disposed on one principal surface of two principal surfaces of the element body from the one end with a predetermined distance, and corresponds to the intracavity electrode;
the protective layer comprises an inner layer covering the element body and an outer layer positioned outside the inner layer on at least the one principal surface on which the extracavity electrode exists; and
the protective layer has, on the one principal surface on which the extracavity electrode exists, a main region including an electrode presence region in which the extracavity electrode exists and a posterior region following to the electrode presence region; and an anterior region from the one end in the longitudinal direction of the base part to the electrode presence region, in the longitudinal direction of the base part; and wherein
a porosity in the anterior region of the inner layer is lower than a porosity in the main region of the inner layer, and
a porosity of the outer layer is lower than the porosity in the anterior region of the inner layer.

(2) The sensor element according to the above (1), wherein the porosity in the anterior region of the inner layer is lower than the porosity in the main region of the inner layer by 5% by volume or more.

(3) The sensor element according to the above (1) or (2), wherein the porosity in the anterior region of the inner layer is lower than the porosity in the main region of the inner layer by 10% by volume or more.

(4) The sensor element according to any one of the above (1) to (3), wherein the posterior region of the protective layer extends in the longitudinal direction of the base part to a position farther from the one end in the longitudinal direction of the base part than the measurement-object gas flow cavity.

(5) The sensor element according to any one of the above (1) to (4), wherein, on the one principal surface on which the extracavity electrode exists, a porosity of the inner layer is stepwise or continuously increased in the longitudinal direction of the base part from the one end in the longitudinal direction of the base part.

### Advantageous Effect of the Invention

According to the present invention, it is possible to provide a sensor element that has high water resistance and maintains high measurement accuracy.

### BRIEF DESCRIPTION OF THE DRAWINGS

FIG. 1 is a perspective view, showing one example of a schematic configuration of a sensor element 101.

FIG. 2 is a vertical sectional schematic view in the longitudinal direction, showing one example of a schematic configuration of a gas sensor 100 including the sensor element 101. FIG. 2 includes a sectional schematic view of the sensor element 101 along a line II-II in FIG. 1.

FIG. 3 is a schematic sectional view of the same section as shown in FIG. 2, which shows the structure of a porous protective layer 90. In FIG. 3, the components inside an element body 102 are not shown except for a measurement-object gas flow cavity 15, intracavity electrodes and an extracavity electrode.

FIG. 4 is a schematic sectional view taken along a line IV-IV shown in FIG. 3. In FIG. 4, the components inside the element body 102 are not shown except for the measurement-object gas flow cavity 15 (a buffer space 12).

FIG. 5 is a conceptual diagram showing a principle of reducing measurement accuracy of oxygen in a conventional sensor element.

FIG. 6 is a conceptual diagram showing diffusion of oxygen pumped out from a first internal cavity 20 in the sensor element 101 of one embodiment of the present invention.

FIG. 7 is a flowchart showing an example of a production method of the sensor element.

### MODES FOR CARRYING OUT OF THE INVENTION

A sensor element of the present invention includes:
an element body that includes a base part in an elongated plate shape, including an oxygen-ion-conductive solid electrolyte layer, and a measurement-object gas flow cavity formed on a side of one end in a longitudinal direction of the base part; and
a porous protective layer that is formed from the one end in the longitudinal direction of the base part and covers a surface of a predetermined length in the longitudinal direction of the element body.

The element body includes: an intra-cavity electrode disposed in the measurement-object gas flow cavity; and an extra-cavity electrode that has a predetermined length in the longitudinal direction of the base part, is disposed on one principal surface of two principal surfaces of the element body from the one end with a predetermined distance, and corresponds to the intracavity electrode.

The protective layer includes an inner layer covering the element body and an outer layer positioned outside the inner layer on at least the one principal surface on which the extracavity electrode exists; and
the protective layer has, on the one principal surface on which the extracavity electrode exists, a main region including an electrode presence region in which the extracavity electrode exists and a posterior region following to the electrode presence region; and an anterior region from the one end in the longitudinal direction of the base part to the electrode presence region, in the longitudinal direction of the base part; and wherein
a porosity in the anterior region of the inner layer is lower than a porosity in the main region of the inner layer, and
a porosity of the outer layer is lower than the porosity in the anterior region of the inner layer.

Hereinafter, an example of an embodiment of a gas sensor having the sensor element of the present invention will be described in detail.

### [Schematic Configuration of Gas Sensor]

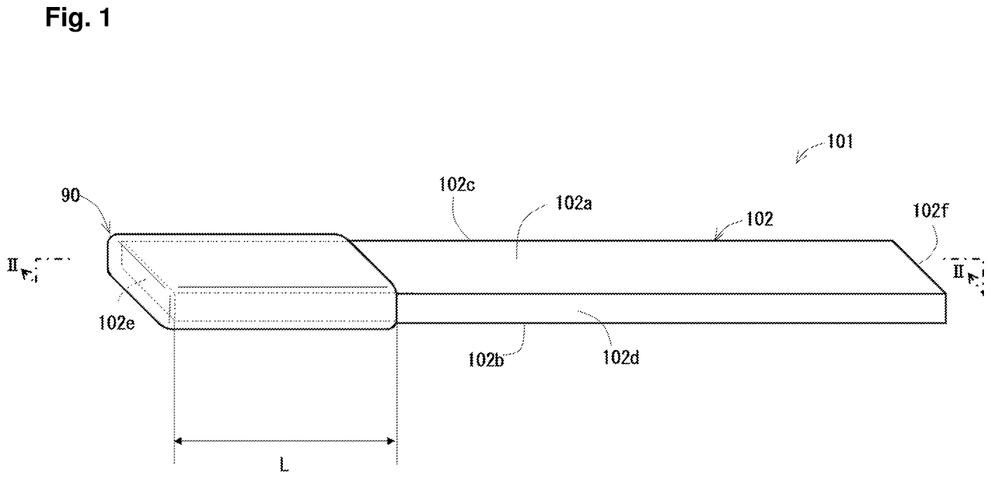

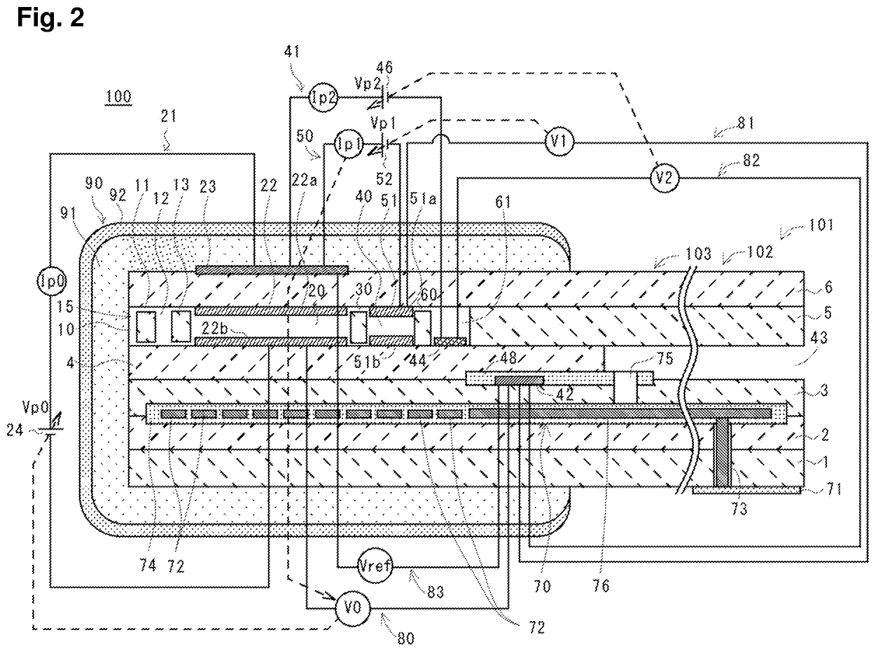

The gas sensor of the present invention will now be described with reference to the drawings. FIG. 1 is a perspective view, showing one example of a schematic configuration of a sensor element 101 included in a gas sensor 100. FIG. 2 is a vertical sectional schematic view in the longitudinal direction, showing one example of a schematic configuration of the gas sensor 100 including the sensor element 101. In FIG. 2, the sectional schematic view of the sensor element 101 is a sectional schematic view along a line II-II in FIG. 1. Hereinafter, based on FIG. 2, the upper side and the lower side in FIG. 2 are respectively defined as top and bottom, and the left side and the right side in FIG. 2 are respectively defined as a front end side and a rear end side. And, based on FIG. 2, the front side and the back side perpendicular to the paper are respectively defined as a right side and a left side.

In FIG. 2, the gas sensor 100 represents one example of a limiting current type NOx sensor that detects NOx in a measurement-object gas by the sensor element 101, and measures the concentration of NOx.

The sensor element 101 includes a porous protective layer 90 that will be described later in detail. The porous protective layer 90 corresponds to a protective layer of the present invention. A part of the sensor element 101 excluding the porous protective layer 90 is hereinafter referred to as an element body 102. The element body 102 has an elongated plate shape. As shown in FIG. 1, the element body 102 has six surfaces including two principal surfaces (a top surface 102a and a bottom surface 102b), two side surfaces along the longitudinal direction (a left surface 102c and a right surface 102d), and two end surfaces in the longitudinal direction (a front end surface 102e and a rear end surface 102f).

Further, the element body 102 of the sensor element 101 includes an intracavity electrode disposed in a measurement-object gas flow cavity 15 that will be described later; and an extracavity electrode that has a predetermined length in the longitudinal direction of the base part 103, is disposed on one principal surface of the two principal surfaces of the element body 102 from the one end with a predetermined distance, and corresponds to the intracavity electrode. The measurement-object gas flow cavity 15 also has a predetermined length in the longitudinal direction of the base part 103. The phrase “corresponds to the intracavity electrode” means that the extracavity electrode is provided to be in contact with the intracavity electrode via the solid electrolyte layer.

In the sensor element 101 of this embodiment, an inner main pump electrode 22, an auxiliary pump electrode 51, and a measurement electrode 44 are provided as intracavity electrodes. As an extracavity electrode, an outer pump electrode 23 is provided on the top surface 102a from the front end of the element body 102 with a predetermined distance.

The sensor element 101 is an element in an elongated plate shape, including a base part 103 having such a structure that a plurality of oxygen-ion-conductive solid electrolyte layers are layered. The elongated plate shape also called a long plate shape or a belt shape. The base part 103 has such a structure that six layers, namely, a first substrate layer 1, a second substrate layer 2, a third substrate layer 3, a first solid electrolyte layer 4, a spacer layer 5, and a second solid electrolyte layer 6, are layered in this order from the bottom side, as viewed in the drawing. Each of the six layers is formed of an oxygen-ion-conductive solid electrolyte layer containing, for example, zirconia (ZrO₂). The solid electrolyte forming these six layers is dense and gastight. These six layers all may have the same thickness, or the thickness may vary among the layers. The layers are adhered to each other with an adhesive layer of a solid electrolyte interposed therebetween, and the base part 103 includes the adhesive layer. While a layer configuration composed of the six layers is illustrated in FIG. 2, the layer configuration in the present invention is not limited to this, and any number of layers and any layer configuration are possible.

A gas inlet 10 is formed between the lower surface of the second solid electrolyte layer 6 and the upper surface of the first solid electrolyte layer 4 in one end part in the longitudinal direction (hereinafter, referred to as a front end part) of the sensor element 101. The measurement-object gas flow cavity 15, that is, a measurement-object gas flow part is formed in such a form that a first diffusion-rate limiting part 11, a buffer space 12, a second diffusion-rate limiting part 13, a first internal cavity 20, a third diffusion-rate limiting part 30, a second internal cavity 40, a fourth diffusion-rate limiting part 60, and a third internal cavity 61 communicate in this order in the longitudinal direction from the gas inlet 10.

The gas inlet 10, the buffer space 12, the first internal cavity 20, the second internal cavity 40, and the third internal cavity 61 constitute internal spaces of the sensor element 101. Each of the internal spaces is provided in such a manner that a portion of the spacer layer 5 is hollowed out, and the top of each of the internal spaces is defined by the lower surface of the second solid electrolyte layer 6, the bottom of each of the internal spaces is defined by the upper surface of the first solid electrolyte layer 4, and the lateral surface of each of the internal spaces is defined by the lateral surface of the spacer layer 5.

Each of the first diffusion-rate limiting part 11, the second diffusion-rate limiting part 13, and the third diffusion-rate limiting part 30 is provided as two laterally elongated slits (having the longitudinal direction of the openings in the direction perpendicular to the figure in FIG. 2). Each of the first diffusion-rate limiting part 11, the second diffusion-rate limiting part 13, and the third diffusion-rate limiting part 30 may be in such a form that a desired diffusion resistance is created, but the form is not limited to the slits.

The fourth diffusion-rate limiting part 60 is provided as a single laterally elongated slit (having the longitudinal direction of the opening in the direction perpendicular to the figure in FIG. 2) between the spacer layer 5 and the second solid electrolyte layer 6. The fourth diffusion-rate limiting part 60 may be in such a form that a desired diffusion resistance is created, but the form is not limited to the slit.

Also, at a position farther from the front end than the measurement-object gas flow cavity 15, a reference gas introduction space 43 is disposed between the upper surface of the third substrate layer 3 and the lower surface of the spacer layer 5 at a position where the reference gas introduction space 43 is laterally defined by the lateral surface of the first solid electrolyte layer 4. The reference gas introduction space 43 has an opening in the other end part (hereinafter, referred to as a rear end part) of the sensor element 101. As a reference gas for NOx concentration measurement, for example, air is introduced into the reference gas introduction space 43.

An air introduction layer 48 is a layer formed of porous alumina, and is so configured that a reference gas is introduced into the air introduction layer 48 via the reference gas introduction space 43. The air introduction layer 48 is formed to cover a reference electrode 42.

The reference electrode 42 is an electrode sandwiched between the upper surface of the third substrate layer 3 and the first solid electrolyte layer 4, and as described above, the air introduction layer 48 leading to the reference gas introduction space 43 is disposed around the reference electrode 42. That is, the reference electrode 42 is disposed to be in contact with a reference gas via the air introduction layer 48 which is a porous material, and the reference gas introduction space 43. As will be described later, the reference electrode 42 can be used to measure the oxygen concentration (oxygen partial pressure) in the first internal cavity 20, the second internal cavity 40, and the third internal cavity 61. The reference electrode 42 is formed as a porous cermet electrode (e.g., a cermet electrode of Pt and ZrO₂).

In the measurement-object gas flow cavity 15, the gas inlet 10 is open to the external space, and the measurement-object gas is taken into the sensor element 101 from the external space through the gas inlet 10.

In the present embodiment, the measurement-object gas flow cavity 15 is in such a form that the measurement-object gas is introduced through the gas inlet 10 that is open on the front end surface of the sensor element 101, however, the present invention is not limited to this form. For example, the measurement-object gas flow cavity 15 need not have a recess of the gas inlet 10. In this case, the first diffusion-rate limiting part 11 substantially serves as a gas inlet.

Further, for example, the measurement-object gas flow cavity 15 may be so configured that the measurement-object gas is introduced through a porous body.

The first diffusion-rate limiting part 11 creates a predetermined diffusion resistance to the measurement-object gas taken through the gas inlet 10.

The buffer space 12 is provided to guide the measurement-object gas introduced from the first diffusion-rate limiting part 11 to the second diffusion-rate limiting part 13.

The second diffusion-rate limiting part 13 creates a predetermined diffusion resistance to the measurement-object gas introduced into the first internal cavity 20 from the buffer space 12.

It suffices that the amount of the measurement-object gas to be introduced into the first internal cavity 20 finally falls within a predetermined range. That is, it suffices that a predetermined diffusion resistance is created in a whole from the front end part of the sensor element 101 to the second diffusion-rate limiting part 13. For example, the first diffusion-rate limiting part 11 may directly communicate with the first internal cavity 20, or the buffer space 12 and the second diffusion-rate limiting part 13 may be absent.

The buffer space 12 is provided to mitigate the influence of pressure fluctuation on the detected value when the pressure of the measurement-object gas fluctuates.

When the measurement-object gas is introduced from outside the sensor element 101 into the first internal cavity 20, the measurement-object gas, which is rapidly taken through the gas inlet 10 into the sensor element 101 due to pressure fluctuation of the measurement-object gas in the external space (pulsations in exhaust pressure if the measurement-object gas is automotive exhaust gas), is not directly introduced into the first internal cavity 20. Rather, the measurement-object gas is introduced into the first internal cavity 20 after the pressure fluctuation of the measurement-object gas is eliminated through the first diffusion-rate limiting part 11, the buffer space 12, and the second diffusion-rate limiting part 13. Thus, the pressure fluctuation of the measurement-object gas introduced into the first internal cavity 20 becomes almost negligible.

The first internal cavity 20 is provided as a space for adjusting the oxygen partial pressure in the measurement-object gas introduced through the second diffusion-rate limiting part 13. The oxygen partial pressure is adjusted by operation of a main pump cell 21.

The main pump cell 21 is an electrochemical pump cell including the inner main pump electrode 22 as an intracavity electrode disposed in the measurement-object gas flow cavity 15, and the outer pump electrode 23 as an extracavity electrode disposed to be in contact with the inner main pump electrode 22 via a solid electrolyte (in FIG. 2, via the second solid electrolyte layer 6). The outer pump electrode 23 is disposed on the top surface 102a of the two principal surfaces of the element body 102.

That is, the main pump cell 21 is an electrochemical pump cell composed of the inner main pump electrode 22 having a ceiling electrode portion 22a disposed over substantially the entire surface of the lower surface of the second solid electrolyte layer 6 that faces the first internal cavity 20, the outer pump electrode 23 disposed on a region of the upper surface of the second solid electrolyte layer 6 that corresponds to the ceiling electrode portion 22a so as to be exposed to the external space, and the second solid electrolyte layer 6 sandwiched between the inner main pump electrode 22 and the outer pump electrode 23.

The inner main pump electrode 22 is disposed facing the first internal cavity 20. That is, the inner main pump electrode 22 is formed to span the upper and lower solid electrolyte layers (the second solid electrolyte layer 6 and the first solid electrolyte layer 4) that define the first internal cavity 20 and the spacer layer 5 that defines the lateral wall. Specifically, the ceiling electrode portion 22a is formed on the lower surface of the second solid electrolyte layer 6 that defines the ceiling surface of the first internal cavity 20, and a bottom electrode portion 22b is formed on the upper surface of the first solid electrolyte layer 4 that defines the bottom surface of the first internal cavity 20. Also, lateral electrode portions (not shown) are formed on the lateral wall surfaces (inner surface) of the spacer layer 5 that form both lateral wall parts of the first internal cavity 20 so as to connect the ceiling electrode portion 22a and the bottom electrode portion 22b. Thus, the inner main pump electrode 22 is provided as a tunnel-like structure in the area where the lateral electrode portions are disposed.

The inner main pump electrode 22 and the outer pump electrode 23 are each formed as a porous cermet electrode (e.g., a cermet electrode of Pt containing 1% Au and ZrO₂). It is to be noted that the inner main pump electrode 22 to be in contact with the measurement-object gas is formed using a material having a weakened ability to reduce a NOx component in the measurement-object gas.

In the main pump cell 21, a desired pump voltage Vp0 is applied between the inner main pump electrode 22 and the outer pump electrode 23 by a variable power supply 24 to flow a pump current Ip0 between the inner main pump electrode 22 and the outer pump electrode 23 in either a positive or negative direction, and thus it is possible to pump out oxygen in the first internal cavity 20 to the external space or pump oxygen into the first internal cavity 20 from the external space.

To detect the oxygen concentration (oxygen partial pressure) in the atmosphere in the first internal cavity 20, the inner main pump electrode 22, the second solid electrolyte layer 6, the spacer layer 5, the first solid electrolyte layer 4, the third substrate layer 3, and the reference electrode 42 form an electrochemical sensor cell, namely, an oxygen-partial-pressure detection sensor cell 80 for main pump control.

The oxygen concentration (oxygen partial pressure) in the first internal cavity 20 can be detected from an electromotive force V0 measured in the oxygen-partial-pressure detection sensor cell 80 for main pump control. In addition, the pump current Ip0 is controlled by performing feedback control of the pump voltage Vp0 in the variable power supply 24 so that the electromotive force V0 is constant. Thus, the oxygen concentration in the first internal cavity 20 can be maintained at a predetermined constant value.

The third diffusion-rate limiting part 30 creates a predetermined diffusion resistance to the measurement-object gas whose oxygen concentration (oxygen partial pressure) has been controlled in the first internal cavity 20 by the operation of the main pump cell 21, and guides the measurement-object gas into the second internal cavity 40.

The second internal cavity 40 is provided as a space for adjusting the oxygen partial pressure in the measurement-object gas introduced through the third diffusion-rate limiting part 30 more accurately. The oxygen partial pressure is adjusted by operation of an auxiliary pump cell 50. The sensor element 101 may be configured without the second internal cavity 40 and the auxiliary pump cell 50. From the viewpoint of adjusting accuracy of oxygen partial pressure, it is more preferred that the second internal cavity 40 and the auxiliary pump cell 50 be provided.

After the oxygen concentration (oxygen partial pressure) in the measurement-object gas is adjusted in advance in the first internal cavity 20, the measurement-object gas is introduced through the third diffusion-rate limiting part 30, and is further subjected to adjustment of the oxygen partial pressure by the auxiliary pump cell 50 in the second internal cavity 40. Thus, the oxygen concentration in the second internal cavity 40 can be kept constant with high accuracy, and the NOx concentration can be measured with high accuracy in the gas sensor 100.

The auxiliary pump cell 50 is an electrochemical pump cell including the auxiliary pump electrode 51 as an intracavity electrode disposed at a position farther from the front end portion of the base part 103 than the inner main pump electrode 22 in the measurement-object gas flow cavity 15, and the outer pump electrode 23 as an extracavity electrode disposed to be in contact with the auxiliary pump electrode 51 via a solid electrolyte (in FIG. 2, via the second solid electrolyte layer 6).

That is, the auxiliary pump cell 50 is an auxiliary electrochemical pump cell composed of the auxiliary pump electrode 51 having a ceiling electrode portion 51a disposed on substantially the entire surface of the lower surface of the second solid electrolyte layer 6 facing with the second internal cavity 40, the outer pump electrode 23 (the outer electrode is not limited to the outer pump electrode 23, but may be any suitable electrode at a position different from the measurement-object gas flow cavity 15, for example, outside the sensor element 101), and the second solid electrolyte layer 6.

The auxiliary pump electrode 51 is disposed in the second internal cavity 40 in a tunnel-like structure similar to the inner main pump electrode 22 disposed in the first internal cavity 20. Specifically, in the tunnel-like structure, the ceiling electrode portion 51a is formed on the second solid electrolyte layer 6 that defines the ceiling surface of the second internal cavity 40, a bottom electrode portion 51b is formed on the first solid electrolyte layer 4 that defines the bottom surface of the second internal cavity 40, and lateral electrode portions (not shown) connecting the ceiling electrode portion 51a and the bottom electrode portion 51b are formed on the wall surfaces of the spacer layer 5 that define the lateral walls of the second internal cavity 40.

It is to be noted that the auxiliary pump electrode 51 is formed using a material having a weakened ability to reduce a NOx component in the measurement-object gas, as with the case of the inner main pump electrode 22.

In the auxiliary pump cell 50, by applying a desired voltage Vp1 between the auxiliary pump electrode 51 and the outer pump electrode 23 by a variable power supply 52, it is possible to pump out oxygen in the atmosphere in the second internal cavity 40 to the external space, or pump the oxygen into the second internal cavity 40 from the external space.

To control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electrochemical sensor cell, namely, an oxygen-partial-pressure detection sensor cell 81 for auxiliary pump control.

The auxiliary pump cell 50 performs pumping with the variable power supply 52 whose voltage is controlled on the basis of an electromotive force V1 detected by the oxygen-partial-pressure detection sensor cell 81 for auxiliary pump control. Thus, the oxygen partial pressure in the atmosphere in the second internal cavity 40 is controlled to such a low partial pressure that does not substantially affect measurement of NOx.

In addition, a pump current Ip1 is used for control of the electromotive force of the oxygen-partial-pressure detection sensor cell 80 for main pump control. Specifically, the pump current Ip1 is input to the oxygen-partial-pressure detection sensor cell 80 for main pump control as a control signal to control the electromotive force V0, and thus the gradient of the oxygen partial pressure in the measurement-object gas introduced into the second internal cavity 40 from the third diffusion-rate limiting part 30 is controlled to remain constant. In using as a NOx sensor, the oxygen concentration in the second internal cavity 40 is kept at a constant value of about 0.001 ppm by the actions of the main pump cell 21 and the auxiliary pump cell 50.

The fourth diffusion-rate limiting part 60 creates a predetermined diffusion resistance to the measurement-object gas whose oxygen concentration (oxygen partial pressure) has been controlled to further low in the second internal cavity 40 by the operation of the auxiliary pump cell 50, and guides the measurement-object gas into the third internal cavity 61.

The third internal cavity 61 is provided as a space for measuring nitrogen oxide (NOx) concentration in the measurement-object gas introduced through the fourth diffusion-rate limiting part 60. By the operation of a measurement pump cell 41, NOx concentration is measured.

The measurement pump cell 41 measures NOx concentration in the measurement-object gas in the third internal cavity 61. The measurement pump cell 41 is an electrochemical pump cell including the measurement electrode 44 as an intracavity electrode disposed at a position farther from the front end portion of the base part 103 than the auxiliary pump electrode 51 in the measurement-object gas flow cavity 15, and the outer pump electrode 23 as an extracavity electrode disposed to be in contact with the measurement electrode 44 via a solid electrolyte (in FIG. 2, via the second solid electrolyte layer 6, the spacer layer 5, and the first solid electrolyte layer 4).

That is, the measurement pump cell 41 is an electrochemical pump cell composed of the measurement electrode 44 disposed on the upper surface of the first solid electrolyte layer 4 facing with the third internal cavity 61, the outer pump electrode 23 (the outer electrode is not limited to the outer pump electrode 23, but may be any suitable electrode at a position different from the measurement-object gas flow cavity 15, for example, outside the sensor element 101), the second solid electrolyte layer 6, the spacer layer 5, and the first solid electrolyte layer 4.

The measurement electrode 44 is a porous cermet electrode. The measurement electrode 44 functions also as a NOx reduction catalyst that reduces NOx present in the atmosphere in the third internal cavity 61. The measurement electrode 44 contains a noble metal having catalytic activity (e.g., at least one of Pt, Rh, Ir, Ru, and Pd) as a metal component.

In the measurement pump cell 41, oxygen generated by decomposition of nitrogen oxide in the atmosphere around the measurement electrode 44 is pumped out, and the amount of generated oxygen can be detected as a pump current Ip2.

To detect the oxygen partial pressure around the measurement electrode 44, the first solid electrolyte layer 4, the third substrate layer 3, the measurement electrode 44, and the reference electrode 42 constitute an electrochemical sensor cell, namely an oxygen-partial-pressure detection sensor cell 82 for measurement pump control. A variable power supply 46 is controlled on the basis of an electromotive force V2 detected by the oxygen-partial-pressure detection sensor cell 82 for measurement pump control.

The measurement-object gas introduced into the second internal cavity 40 reaches the measurement electrode 44 through the fourth diffusion-rate limiting part 60 under the condition that the oxygen partial pressure is controlled. Nitrogen oxide in the measurement-object gas around the measurement electrode 44 is reduced (2NO→N₂+O₂) to generate oxygen. The generated oxygen is to be pumped by the measurement pump cell 41, and at this time, a voltage Vp2 of the variable power supply 46 is controlled so that the electromotive force V2 detected by the oxygen-partial-pressure detection sensor cell 82 for measurement pump control is constant. Since the amount of oxygen generated around the measurement electrode 44 is proportional to the concentration of nitrogen oxide in the measurement-object gas, nitrogen oxide concentration in the measurement-object gas is calculated by using the pump current Ip2 in the measurement pump cell 41.

By configuring oxygen partial pressure detecting means by an electrochemical sensor cell composed of a combination of the measurement electrode 44, the first solid electrolyte layer 4, the third substrate layer 3 and the reference electrode 42, it is possible to detect an electromotive force in accordance with a difference between the amount of oxygen generated by reduction of NOx components in the atmosphere around the measurement electrode 44 and the amount of oxygen contained in the reference air, and hence it is possible to determine the concentration of NOx components in the measurement-object gas.

Also, the second solid electrolyte layer 6, the spacer layer 5, the first solid electrolyte layer 4, the third substrate layer 3, the outer pump electrode 23, and the reference electrode 42 constitute an electrochemical sensor cell 83, and it is possible to detect the oxygen partial pressure in the measurement-object gas outside the sensor by an electromotive force Vref obtained by the sensor cell 83.

In the gas sensor 100 having such a configuration, the main pump cell 21 and the auxiliary pump cell 50 are operated to supply a measurement-object gas whose oxygen partial pressure is usually kept at a low constant value (the value that does not substantially affect measurement of NOx) to the measurement pump cell 41. Therefore, NOx concentration in the measurement-object gas can be detected on the basis of the pump current Ip2 that flows as a result of pumping out of the oxygen generated by reduction of NOx by the measurement pump cell 41 and is almost in proportion to the concentration of NOx in the measurement-object gas.

The sensor element 101 further includes a heater part 70 that functions as a temperature regulator of heating and maintaining the temperature of the sensor element 101 so as to enhance the oxygen ion conductivity of the solid electrolyte. The heater part 70 includes a heater electrode 71, a heater 72, a heater lead 76, a through hole 73, a heater insulating layer 74, and a pressure relief vent 75.

The heater electrode 71 is an electrode formed in contact with the lower surface of the first substrate layer 1. The power can be supplied to the heater part 70 from the outside by connecting the heater electrode 71 with a heater power supply that is an external power supply.

The heater 72 is an electrical resistor sandwiched by the second substrate layer 2 and the third substrate layer 3 from top and bottom. The heater 72 is connected with the heater electrode 71 via the heater lead 76 that connects with the heater 72 and extends in the rear end side in the longitudinal direction of the sensor element 101, and the through hole 73. The heater 72 is externally powered through the heater electrode 71 to generate heat, and heats and maintains the temperature of the solid electrolyte forming the sensor element 101.

The heater 72 is embedded over the whole area from the first internal cavity 20 to the third internal cavity 61 so that the temperature of the entire sensor element 101 can be adjusted to such a temperature that activates the solid electrolyte. The temperature may be adjusted so that the main pump cell 21, the auxiliary pump cell 50, and the measurement pump cell 41 are operable. It is not necessary that the whole area is adjusted to the same temperature, but the sensor element 101 may have temperature distribution.

In the sensor element 101 of the present embodiment, the heater 72 is embedded in the base part 103, but this form is not limitative. The heater 72 may be disposed to heat the base part 103. That is, the heater 72 may heat the sensor element 101 to develop oxygen ion conductivity with which the main pump cell 21, the auxiliary pump cell 50, and the measurement pump cell 41 are operable. For example, the heater 72 may be embedded in the base part 103 as in the present embodiment. Alternatively, for example, the heater part 70 may be formed as a heater substrate that is separate from the base part 103, and may be disposed at a position adjacent to the base part 103.

The heater insulating layer 74 is formed of an insulator such as alumina on the upper and lower surfaces of the heater 72 and the heater lead 76. The heater insulating layer 74 is formed to ensure electrical insulation between the second substrate layer 2, and the heater 72 and the heater lead 76, and electrical insulation between the third substrate layer 3, and the heater 72 and the heater lead 76.

The pressure relief vent 75 extends through the third substrate layer 3 so that the heater insulating layer 74 and the reference gas introduction space 43 communicate with each other. The pressure relief vent 75 can mitigate an increase in internal pressure due to temperature rise in the heater insulating layer 74. The pressure relief vent 75 may be absent.

### (Protective Layer)

The sensor element 101 includes the element body 102 and the porous protective layer 90 that is formed from the one end in the longitudinal direction of the element body 102 (the base part 103) and covers a surface of a predetermined length L in the longitudinal direction of the element body 102. Here, the one end in the longitudinal direction of the element body 102 is the one end on a side of which the measurement-object gas flow cavity 15 is formed, namely, the front end of the element body 102. The element body 102 is in an elongated plate shape, and the top surface 102a and the bottom surface 102b of the element body 102 are principal surfaces. The left surface 102c and the right surface 102d are also referred to as the side surfaces, and the front end surface 102e and the rear end surface 102f are also referred to as the end surfaces.

The porous protective layer 90 includes an inner layer 91 covering the element body 102 and an outer layer 92 positioned outside the inner layer 91 on at least the one principal surface (the top surface 102a) on which the extracavity electrode (in this embodiment, the outer pump electrode 23) exists. Further, the porous protective layer 90 has, on the one principal surface (the top surface 102a), a main region including an electrode presence region in which the extracavity electrode exists and a posterior region following to the other end side of the electrode presence region; and an anterior region from the one end in the longitudinal direction of the base part to the electrode presence region, in the longitudinal direction of the element body 102 (the base part 103).

The porous protective layer 90 comprises a porous material. Examples of a constituent material of the porous protective layer 90 include alumina, zirconia, spinel, cordierite, mullite, titania, and magnesia. Any one or two or more of them may be used. A constituent material of the inner layer 91 and a constituent material of the outer layer 92 may be the same, or may be different from each other. In this embodiment, the porous protective layer 90 (the inner layer 91 and the outer layer 92) comprises an alumina porous material.

In this embodiment, the porous protective layer 90 covers a predetermined area (an area indicated by a broken line in FIG. 1) of the element body 102 in the longitudinal direction from the front end of the element body 102. In more detail, the porous protective layer 90 entirely covers a part of the top surface 102a of the element body 102 which extends for a predetermined length L in the longitudinal direction from the front end of the element body 102. The porous protective layer 90 entirely covers a part of the bottom surface 102b of the element body 102 which extends for a length L in the longitudinal direction from the front end of the element body 102. The porous protective layer 90 entirely covers a part of the left surface 102c of the element body 102 which extends for a length L in the longitudinal direction from the front end of the element body 102. The porous protective layer 90 entirely covers a part of the right surface 102d of the element body 102 which extends for a length L in the longitudinal direction from the front end of the element body 102. The porous protective layer 90 entirely covers the front end surface 102e of the element body 102.

The inner layer 91 is formed so as to cover a predetermined area from the front end of the element body 102 on at least one principal surface (the top surface 102a) on which the extracavity electrode (the outer pump electrode 23) exists. In this embodiment, the inner layer 91 entirely covers a part of the surface of the element body 102 which extends for a predetermined length L in the longitudinal direction from the front end of the element body 102. In this embodiment, the outer layer 92 is formed to cover the entire surface of the inner layer 91. That is, the outer layer 92 entirely covers a part of the surface of the inner layer 91 which extends for a predetermined length L in the longitudinal direction from the front end of the element body 102.

As such, the porous protective layer 90 is constituted from two layers of the inner layer 91 and the outer layer 92 on each of surfaces (the top surface 102a, the bottom surface 102b, the left surface 102c, the right surface 102d, and the front end surface 102c) of the element body 102. That is, in this embodiment, a length in the longitudinal direction from the front end of the element body 102 in the inner layer 91 and a length in the longitudinal direction from the front end of the element body 102 in the outer layer 92 are substantially the same. Hereinafter, the top surface 102a is also referred to as a pump surface 102a. One principal surface (the bottom surface 102b) of the two principal surfaces of the element body 102 opposite to the pump surface 102a is also referred to as a heater surface 102b.

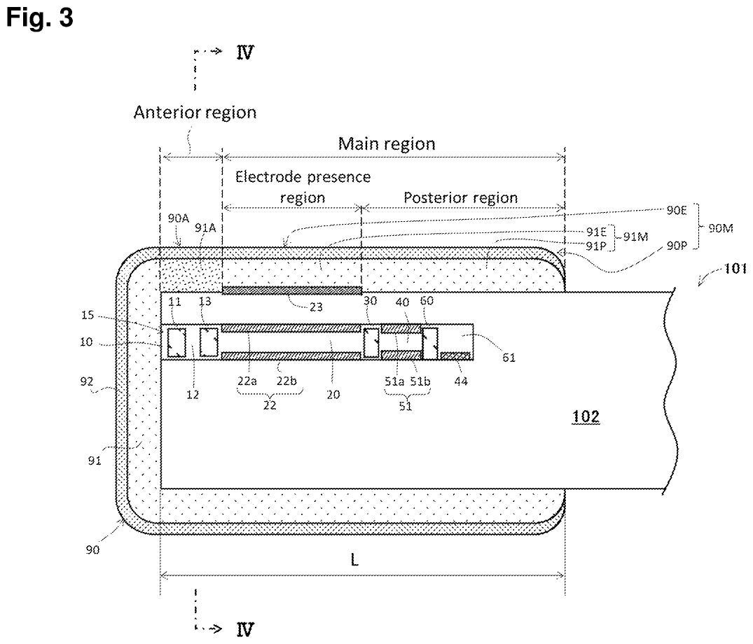

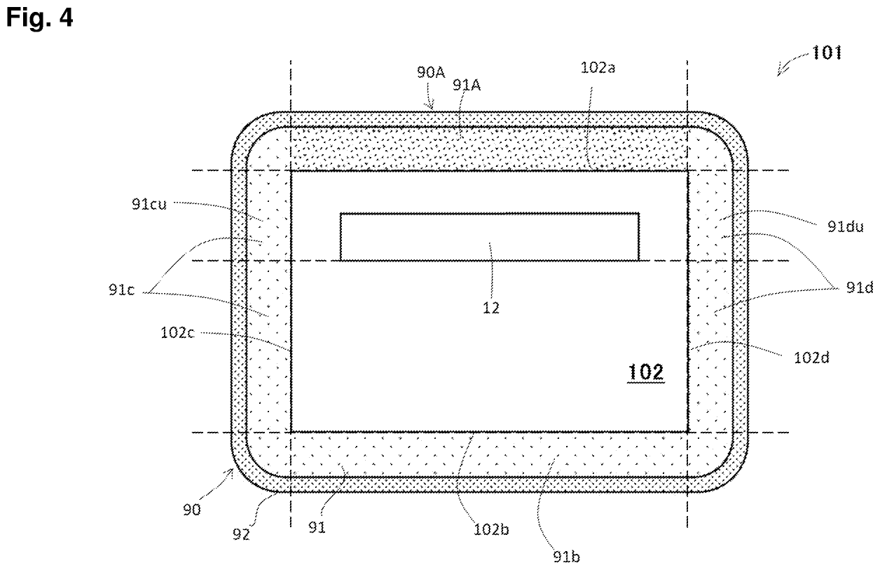

FIG. 3 is a schematic sectional view of the same section as shown in FIG. 2, which shows the structure of the porous protective layer 90. In FIG. 3, the components inside the element body 102 are not shown except for the measurement-object gas flow cavity 15, the intracavity electrodes and the extracavity electrode. FIG. 4 is a schematic sectional view taken along a line IV-IV shown in FIG. 3, that is, a schematic sectional view of the sensor element 101 perpendicular to the longitudinal direction of the sensor element 101. FIG. 4 shows a horizontal section of the porous protective layer 90 on the top surface of the element body 102. In FIG. 4, the components inside the element body 102 are not shown except for the measurement-object gas flow cavity 15 (the buffer space 12).

As shown in FIG. 3, the outer pump electrode 23 is disposed on the pump surface 102a from the front end of the element body 102 (the base part 103) with a predetermined distance. The outer pump electrode 23 may be disposed at such a position that oxygen can be pumped out from each of the internal cavities 20, 40, 61. The predetermined distance from the front end of the element body 102 is not particularly limited, and the outer pump electrode 23 may be disposed on a position corresponding to the intracavity electrode (at least any one of the inner main pump electrode 22, the auxiliary pump electrode 51, and the measurement electrode 44) in the longitudinal direction of the element body 102 (the base part 103). For example, the outer pump electrode 23 may be disposed on a position corresponding to at least any one of the internal cavities 20, 40, 61. For example, the outer pump electrode 23 may be disposed on a position corresponding to the first internal cavity 20. The outer pump electrode 23 may be disposed from the front end of the element body 102 with a predetermined distance corresponding to a prior part (a part from the gas inlet 10 to the second diffusion-rate limiting part 13) for introducing a measurement-object gas into the first internal cavity 20.

As shown in FIG. 3, in the longitudinal direction of the element body 102 (the base part 103), a region in which the outer pump electrode 23 exists in the porous protective layer 90 on the pump surface 102a of the element body 102 is referred to as an electrode presence region 90E. A region following to the rear of the electrode presence region 90E, that is, a region from a rear end of the electrode presence region 90E to a rear end of the porous protective layer 90 in the porous protective layer 90 on the pump surface 102a of the element body 102 is referred to as a posterior region 90P. The posterior region 90P is a region from a position in the electrode presence region 90E the farthest from the one end (the front end) of the element body 102, to a position in the porous protective layer 90 the farthest from the one end (the front end) of the element body 102 (to the rear end of the porous protective layer 90). A region composed of the electrode presence region 90E and the posterior region 90P is referred to as a main region 90M. A region from the front end of the element body 102 (the base part 103) to the front end of the electrode presence region 90E in the porous protective layer 90 on the pump surface 102a of the element body 102 is referred to as an anterior region 90A. That is, the anterior region 90A is a region occupying the predetermined distance from the one end (the front end) in the longitudinal direction of the element body 102 to a position in the electrode presence region 90E the nearest from the one end (the front end) of the element body 102. The rear end of the anterior region 90A is in contact with the front end of the electrode presence region 90E, and the rear end of the electrode presence region 90E is in contact with the front end of the posterior region 90P. The rear end of the anterior region 90A is in contact with the front end of the main region 90M.

In the porous protective layer 90, a porosity in an anterior region 91A of the inner layer 91 is lower than a porosity in a main region 91M of the inner layer 91. The anterior region 91A of the inner layer 91 is a region occupying a part with a predetermined length in the longitudinal direction (the predetermined distance) from the one end (the front end) in the longitudinal direction of the element body 102 to one electrode end (a front end) of the outer pump electrode 23 on a side near the one end of the element body 102 in the inner layer 91. Further, a porosity of the outer layer 92 is lower than the porosity in the anterior region 91A of the inner layer 91. The porosity of the outer layer 92 is usually lower than a porosity at any position in the inner layer 91. The porosity will be described later in detail.

As shown in FIG. 3, in the porous protective layer 90 of this embodiment, the inner layer 91 on the front end surface 102e does not have a region with a low porosity corresponding to that of the anterior region 91A, and has a porosity equivalent to the porosity in the main region 91M. Further, as shown in FIG. 4, in the porous protective layer 90 of this embodiment, the inner layers 91b, 91c, 91d on respective surfaces 102b, 102c, 102d other than the pump surface 102a in the inner layer 91 do not have a region with a low porosity corresponding to that of the anterior region 91A, and have a porosity equivalent to the porosity in the main region 91M over a whole area in the longitudinal direction. Also, in the porous protective layer 90 of this embodiment, each of corner portions shown in FIG. 3 and FIG. 4 does not have a region with the low porosity corresponding to that of the anterior region 91A, and has a porosity equivalent to the porosity in the main region 91M.

As shown in FIG. 2 and FIG. 3, the porous protective layer 90 also covers the gas inlet 10. However, a measurement-object gas can reach the gas inlet 10 through the inside of the porous protective layer 90 because the porous protective layer 90 is a porous material. Therefore, a target gas to be measured can be detected and measured without problem.

The porous protective layer 90 plays a role of suppressing the occurrence of cracking in the internal structure of the element body 102 when, for example, water is splashed on the sensor element 101 having a high temperature during operation of the gas sensor. Water that has reached the sensor element 101 is not directly attached to the surface of the element body 102 but is attached to the porous protective layer 90. The surface of the porous protective layer 90 is rapidly cooled by the attached water, but thermal shock applied to the element body 102 is reduced by the heat insulating effect of the porous protective layer 90. This, as a result, makes it possible to suppress the occurrence of cracking in the internal structure of the element body 102. That is, the water resistance of the sensor element 101 improves.

In the porous protective layer 90, the inner layer 91 mainly plays a role of suppressing thermal conduction from the surface of the sensor element 101 (the surface of the porous protective layer 90) to the element body 102. In other words, the inner layer 91 has a function of reducing thermal shock applied to the element body 102 by the heat insulating effect of the inner layer 91. Further, the outer layer 92 having a lower porosity than the inner layer 91 mainly has a function of maintaining structural strength of the porous protective layer 90 as a whole. The outer layer 92 also has a function of preventing water droplets from penetrating into the inside of the porous protective layer 90 (the inside of the inner layer 91). This prevents evaporation of water inside the inner layer 91 and reduces thermal shock applied to the element body 102.

The porous protective layer 90 covers the outer pump electrode 23. The porous protective layer 90 also plays a role of suppressing the attachment of an oil component or the like contained in a measurement-object gas to the outer pump electrode 23 to prevent degradation of the outer pump electrode 23.

The present inventors have found that, in a conventional sensor element provided with a porous protective layer including an inner layer and an outer layer, measurement accuracy of a target gas to be measured (e.g., oxygen O₂, nitrogen oxide NOx or the like) may be decreased when a gas sensor is continuously driven for a long time. It is considered that the measurement accuracy of oxygen may be particularly decreased.

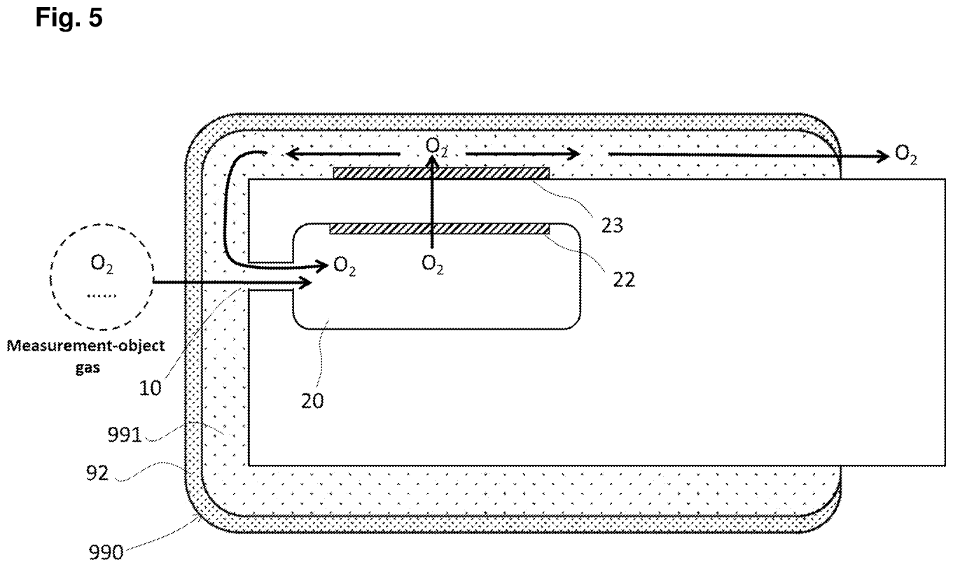

The present inventors have intensively studied reasons for the above. FIG. 5 is a conceptual diagram showing a principle of reducing measurement accuracy of oxygen in a conventional sensor element. In FIG. 5, the gas inlet 10, the first internal cavity 20, the inner main pump electrode 22, and the outer pump electrode 23 in the configuration of the element body 102 are conceptually shown for convenience of explanation. That is, the configuration of the main pump cell is conceptually shown. Further, only oxygen O₂ is shown among gas components in a measurement-object gas. In FIG. 5, a porous protective layer 990 is composed of an inner layer 991 having a uniform porosity and an outer layer 92 having a lower porosity than the inner layer 991. A measurement-object gas is introduced into the first internal cavity 20 from the gas inlet 10. Oxygen in the measurement-object gas is pumped out from the first internal cavity 20 to the outside of the element body 102 (to the inside of the inner layer 991 in the vicinity of the outer pump electrode 23) by applying a voltage between the inner main pump electrode 22 and the outer pump electrode 23. At this time, a pump current corresponding to an oxygen concentration in the measurement-object gas introduced into the first internal cavity 20 flows between the inner main pump electrode 22 and the outer pump electrode 23. Thus, the oxygen concentration in the measurement-object gas can be measured from a current value of the pump current.

The inner layer 991 is covered with the outer layer 92 having a low porosity. Therefore, the oxygen pumped out from the first internal cavity 20 to the vicinity of the outer pump electrode 23 diffuses mainly inside the inner layer 991 in the longitudinal direction of the element body 102. There is a small amount of oxygen that diffuses through the outer layer 92 (not shown). Since the porosity of the inner layer 991 is uniform, the oxygen pumped out is considered to diffuse inside the inner layer 991 in the longitudinal direction toward both of the front end direction and the rear end direction of the element body 102 in the same degree.

The oxygen that has diffused toward the front end direction of the element body 102 after being pumped out from the first internal cavity 20 may be introduced (reintroduced) again into the first internal cavity 20 from the gas inlet 10 in the front end surface 102e of the element body 102. In this case, in addition to the measurement-object gas, oxygen already pumped out from the first internal cavity 20 is to be introduced into the first internal cavity 20. As a result, an oxygen concentration in the first internal cavity 20 is concerned to be higher than an actual oxygen concentration in the measurement-object gas. Since the current value of the pump current flowing between the inner main pump electrode 22 and the outer pump electrode 23 corresponds to an oxygen concentration in the gas introduced into the first internal cavity 20 as described above, it is considered that oxygen concentration calculated from the current value of this pump current may be higher than the actual oxygen concentration in the measurement-object gas. That is, the measurement accuracy of the oxygen concentration is concerned to be reduced. It is also considered that, due to the oxygen concentration in the first internal cavity 20 being higher than the actual oxygen concentration in the measurement-object gas, a concentration of a target gas to be measured (e.g., NOx) other than oxygen in the measurement-object gas may be relatively lower than an actual concentration of the target gas to be measured in the measurement-object gas. As a result, measurement accuracy of the target gas to be measured (e.g., NOx) other than oxygen may also be reduced.

When such a reintroduction into the first internal cavity 20 of the oxygen pumped out from the first internal cavity 20 occurs, the reintroduction is considered to occur continuously. Therefore, it is considered that the longer the gas sensor is driven, the more the oxygen concentration in the first internal cavity 20 gradually increases compared with the actual oxygen concentration in the measurement-object gas. That is, there is concern that measurement accuracy decreases when the gas sensor is driven continuously for a long time.

On the other hand, the oxygen that has diffused toward the rear end direction of the element body 102 is released from the rear end of the porous protective layer 990 to the external space of the sensor element 101. In this case, since the above-described reintroduction into the first internal cavity 20 of the oxygen pumped out from the first internal cavity 20 does not occur, the measurement accuracy of oxygen concentration is maintained.

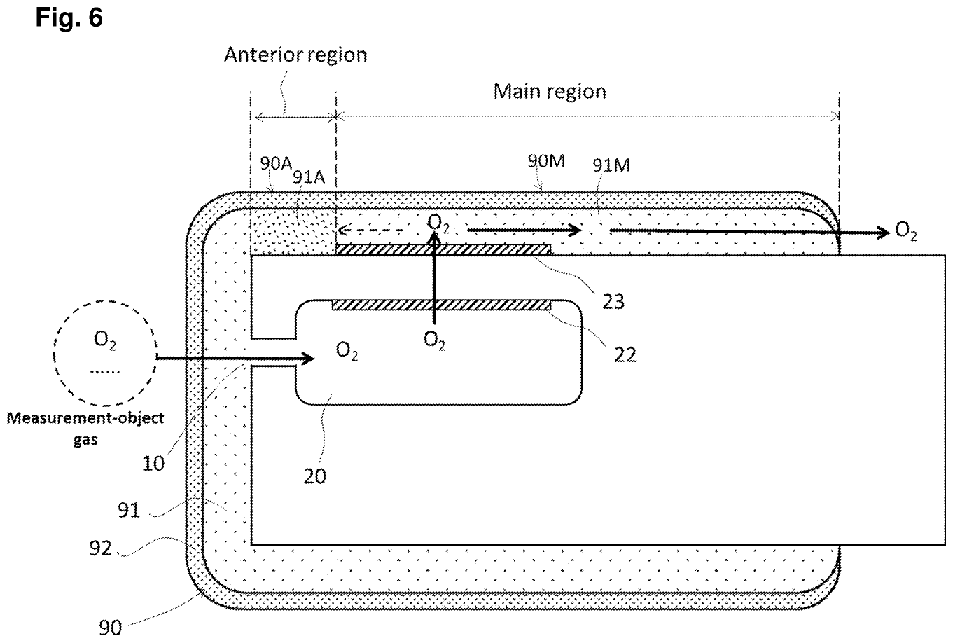

The present inventors have further intensively studied, and have found that the occurrence of the above-described reintroduction can be suppressed by making a porosity of the anterior region 91A in the inner layer 91 of the protective layer (the porous protective layer 90) be lower than a porosity of the main region 91M following to the anterior region 91A. FIG. 6 is a conceptual diagram showing diffusion of oxygen pumped out from the first internal cavity 20 in the sensor element 101 of one embodiment of the present invention. In FIG. 6, as in the case of FIG. 5, the gas inlet 10, the first internal cavity 20, the inner main pump electrode 22, and the outer pump electrode 23 in the configuration of the element body 102 are conceptually shown for convenience of explanation. Further, only oxygen O₂ is shown among gas components in a measurement-object gas.

As in the case of the conventional sensor element, oxygen pumped out from the first internal cavity 20 diffuses mainly inside the inner layer 91 in the longitudinal direction of the element body 102. However, since the porosity of the anterior region 91A in the inner layer 91 is lower than the porosity of the main region 91M in the inner layer 91, diffusion toward the front end direction (dashed arrow) of the element body 102 is suppressed, and diffusion toward the rear end direction (solid arrow) becomes main. The oxygen that has diffused toward the rear end direction of the element body 102 is released from the rear end of the porous protective layer 90 to the external space of the sensor element 101. Accordingly, in the sensor element 101, the occurrence of the reintroduction into the first internal cavity 20 of the oxygen pumped out from the first internal cavity 20 can be suppressed, and thus the measurement accuracy of oxygen concentration can be highly maintained. The diffusion toward the rear end direction can be further promoted by providing difference in a porosity between the anterior region 91A and the main region 91M to further suppress the above-described reintroduction, and therefore the measurement accuracy of oxygen concentration can be highly maintained.

The porous protective layer 90 (especially, the inner layer 91) may cover a portion having a high temperature during the driving of the gas sensor in the element body 102. The length L in the longitudinal direction of the porous protective layer 90 and a length LA in the longitudinal direction of the inner layer 91 may be appropriately determined to fall within a range longer than a length in the longitudinal direction from the front end surface of the element body 102 to a rear electrode end of the extracavity electrode (the outer pump electrode 23) and equal to or shorter than a whole length of the element body 102 in the longitudinal direction, on the basis of the area of the element body 102 to be exposed to a measurement-object gas in the gas sensor 100, the position of the outer pump electrode 23, the position of the measurement-object gas flow cavity 15, temperature distribution of the element body 102, or the like.

The porous protective layer 90 covers at least a part from the front end of the element body 102 to the rear electrode end of the outer pump electrode 23 in the longitudinal direction of the element body 102. Preferably, the porous protective layer 90 may cover at least a part from the front end of the element body 102 to a position at a rear end of the measurement-object gas flow cavity 15. That is, the posterior region 90P of the porous protective layer 90 (a posterior region 91P of the inner layer 91) may extend in the longitudinal direction of the base part 103 to a position farther from the one end (the front end) in the longitudinal direction of the base part 103 than the measurement-object gas flow cavity 15. The position where the measurement-object gas flow cavity 15 exists is usually at such a high temperature that oxygen ion conductivity of the solid electrolyte is developed during the driving of the gas sensor. By covering such a range with the porous protective layer 90, it is possible to effectively reduce thermal shock applied to a portion with high temperature in the element body 102.

For example, the porous protective layer 90 may almost entirely cover a portion exposed to the measurement-object gas in the element body 102. For example, the porous protective layer 90 may be formed to cover almost the entirety from the front end of the element body 102 to a position in the longitudinal direction in which the reference electrode 42 is formed. Alternatively, for example, the porous protective layer 90 may be formed to cover almost the entirety from the front end of the element body 102 to a position of a front end-side side surface of the reference gas introduction space 43 in the longitudinal direction. Alternatively, the porous protective layer 90 may cover almost from the front end of the element body 102 to a position farther from the position of the front end-side side surface of the reference gas introduction space 43 in the longitudinal direction. In this embodiment, on all the surfaces of the two principal surfaces (the pump surface 102a and the heater surface 102b) and two side surfaces (the left surface 102c and the right surface 102d), the respective lengths L in the longitudinal direction of the porous protective layer 90 are the same. However, the lengths L in the longitudinal direction of the porous protective layer 90 on the two principal surfaces and two side surfaces may be different from each other.

The length L of the entire porous protective layer 90 in the longitudinal direction from the front end of the element body 102 may vary depending on the structure of the element body 102, and may be, for example, 7 mm or more, 9 mm or more, or 10 mm or more. The length L may be, for example, 17 mm or less, or 14 mm or less. In this embodiment, on all the surfaces of the two principal surfaces (the pump surface 102a and the heater surface 102b) and two side surfaces (the left surface 102c and the right surface 102d), the respective lengths L in the longitudinal direction of the porous protective layer 90 are the same. However, the lengths L in the longitudinal direction of the porous protective layer 90 on the two principal surfaces and two side surfaces may be different from each other.

The outer layer 92 may cover the inner layer 91 so as to maintain structural strength of the porous protective layer 90 as a whole. As shown in FIG. 3, a length in the longitudinal direction of the outer layer 92 from the front end of the element body 102 may be the same as the length in the longitudinal direction of the inner layer 91 from the front end of the element body 102. The outer layer 92 may completely cover the inner layer 91 (the length in the longitudinal direction of the outer layer 92 from the front end of the element body 102 is longer than that of the inner layer 91). A part including the rear end in the longitudinal direction of the inner layer 91 may be exposed (the length in the longitudinal direction of the inner layer 91 from the front end of the element body 102 is longer than that of the outer layer 92). In this embodiment, on each surface of the two principal surfaces (the pump surface 102a and the heater surface 102b) and two side surfaces (the left surface 102c and the right surface 102d), the length in the longitudinal direction of the outer layer 92 and the length in the longitudinal direction of the inner layer 91 are the same. However, magnitude relations between the length in the longitudinal direction the outer layer 92 and the length in the longitudinal direction of the inner layer 91 on respective surfaces may be different from each other.

A thickness of the inner layer 91 may be, for example, 200 μm or more and 800 μm or less. In this embodiment, the inner layers 91 of the porous protective layers 90 on respective surfaces of the element body 102 all have the same thickness. However, the inner layer 91 on the respective surfaces may be different from each other in thickness. A thickness of the outer layer 92 may be 100 μm or more and 400 μm or less. In this embodiment, the outer layers 92 of the porous protective layers 90 on respective surfaces of the element body 102 all have the same thickness. However, the outer layer 92 on the respective surfaces may be different from each other in thickness.

The thickness is determined in the following manner using an image (SEM image) obtained by observation with a scanning electron microscope (SEM). In an area where the element body 102 is present (for example, a position around center in the width direction of the sensor element 101), the sensor element 101 is cut in the longitudinal direction of the sensor element 101. The cut surface is embedded in a resin and polished to prepare an observation sample. The magnification of the SEM is set to 80 times, and the surface to be observed of the observation sample is imaged to obtain an SEM image of section of the porous protective layer 90. A direction perpendicular to the surface of the element body 102 is defined as a thickness direction, a distance between the surface of the outer layer 92 (the surface of the porous protective layer 90) and the interface with the inner layer 91 is determined, and the distance is defined as the thickness of the outer layer 92. A distance between the surface of the inner layer 91 and the interface with the element body 102 is determined, and the distance is defined as the thickness of the inner layer 91. Further, a distance between the surface of the outer layer 92 (the surface of the porous protective layer 90) and the interface with the element body 102 is determined, and the distance is defined as the thickness of the porous protective layer 90. The thickness of the porous protective layer 90 may also be obtained by calculating a sum of the determined thickness of the outer layer 92 and the determined thickness of the inner layer 91.

As shown in FIG. 3, normally, near the rear end in the longitudinal direction of the porous protective layer 90, the thickness of the inner layer 91 is gradually reduced toward the rear end. Corners of the front end in the longitudinal direction of the porous protective layer 90 are usually rounded. The determination of the thickness described above is carried out in a region having a uniform thickness (in a region other than the front end portion and the rear end portion) of the porous protective layer 90.

Next, a porosity in the inner layer 91 of the porous protective layer 90 will be described with reference to FIG. 3.

As described above, in the inner layer 91, a porosity ρA in the anterior region 91A of the inner layer 91 is lower than a porosity ρM in the main region 91M of the inner layer 91 (ρA<ρM). In other words, a porosity difference Δρ (=ρA−ρM) of the porosity ρA in the anterior region 91A to the porosity ρM in the main region 91M is negative (Δρ<0). As shown in FIG. 3, the present embodiment shows an example in which the anterior region 91A and the main region 91M have respective uniform porosities.

The porosity ρA in the anterior region 91A of the inner layer 91 may preferably be lower than the porosity ρM in the main region 91M of the inner layer 91 by 5% by volume or more. In other words, the porosity difference Δρ (=ρA−ρM) of the porosity ρA in the anterior region 91A to the porosity ρM in the main region 91M may be minus (−) 5% or less (Δρ≤−5%). When the porosity difference Δρ is within such a range, it is possible to further prevent the oxygen pumped out to the vicinity of the outer pump electrode 23 by the main pump cell 21, the auxiliary pump cell 50, and the measurement pump cell 41 from diffusing toward the front end direction of the element body 102. Therefore, it is possible to more effectively prevent the pumped-out oxygen from reintroducing into the measurement-object gas flow cavity 15 through the gas inlet 10. The pumped-out oxygen mainly diffuses toward the rear end direction of the element body 102 and is released from the rear end of the porous protective layer 90 to the external space of the sensor element 101. More preferably, the porosity difference Δρ (=ρA−ρM) may be minus (−) 10% by volume or less (Δρ≤−10%).

A porosity in the anterior region 91A of the inner layer 91 may be, for example, 30% by volume or more and 50% by volume or less. Here, the porosity in the anterior region 91A may be an average porosity in the anterior region 91A. The porosity in the anterior region 91A of the inner layer 91 may be, for example, 30% by volume or more and 45% by volume or less, or, 30% by volume or more and 40% by volume or less.

A porosity in the main region 91M of the inner layer 91 may be, for example, 40% by volume or more and 80% by volume or less. This is based on the premise that the porosity in the main region 91M is higher than the porosity in the anterior region 91A. Here, the porosity in the main region 91M may be an average porosity in the main region 91M. The porosity in the main region 91M of the inner layer 91 may be, for example, 40% by volume or more and 70% by volume or less, or, 40% by volume or more and 60% by volume or less.

A porosity in the inner layer 91 on each of surfaces (the heater surface 102b, the left surface 102c, the right surface 102d, and the front end surface 102e) other than the pump surface 102a of the element body 102 is not particularly limited, and the porosity may be, for example, 30% by volume or more and 80% by volume or less. The porosity in the inner layer 91 on each of the surfaces other than the top surface 102a may be equivalent to the porosity in the main region 91M on the pump surface 102a.

The porosity is determined in the following manner using an image (SEM image) obtained by observation with a scanning electron microscope (SEM). An observation sample is prepared as in the case of determination of the thickness described above, the magnification of the SEM is set to 100 times, and the SEM image of section of the inner layer 91 of the porous protective layer 90 is obtained. In detail, multiple SEM images are obtained over the entire anterior region 91A of the inner layer 91. Each of the obtained SEM images is binarized using “Otsu's method” (also referred to as discriminant analysis method). In the binarized image, alumina is shown in white and pores are shown in black. In each of the binarized images, area of alumina portions (white) and area of pore portions (black) are obtained. The ratio of the area of the pore portions to total area (total of the area of the alumina portions and the area of the pore portions) is calculated in each of the binarized images, and an average value (an average porosity) of the calculated ratios may be used as a porosity in the anterior region 91A of the inner layer 91.

Further, multiple SEM images are obtained over the entire main region 91M of the inner layer 91. The ratio of the area of the pore portions to total area (total of the area of the alumina portions and the area of the pore portions) is calculated in each of the obtained images as in the case of the anterior region 91A described above, and an average value (an average porosity) of the calculated ratios may be used as a porosity in the main region 91M of the inner layer 91.

As a porosity in the anterior region 91A of the inner layer 91, a porosity at a predetermined position in the longitudinal direction of the anterior region 91A may be used instead of the average porosity. For example, a porosity at a center position of the anterior region 91A may be used. Further, as a porosity in the main region 91M of the inner layer 91, a porosity at a predetermined position in the longitudinal direction of the main region 91M may be used instead of the average porosity. For example, a porosity at a center position of the main region 91M may be used. Alternatively, a porosity at a position of the rear end-side electrode end of the outer pump electrode 23 (a rear end of an electrode presence region 91E) in the main region 91M may be used.

A porosity of the outer layer 92 is lower than a porosity at any position in the inner layer 91 as described above. The porosity of the outer layer 92 may be, for example, about 10% by volume or more and 35% by volume or less. This is based on the premise that the porosity of the outer layer 92 is lower than a porosity at any position in the anterior region 91A and the main region 91M of the inner layer 91. The porosity of the outer layer 92 may be also determined using the above-described determination method of the porosity. The outer layer 92 is considered to have substantially the same porosity regardless of observation area. Therefore, the porosity determined using one sectional image may be used as the porosity of the outer layer 92.

The sensor element 101 and the gas sensor 100 including the sensor element 101 for detecting NOx concentration in a measurement-object gas have been described above as examples of the embodiment according to the present invention, but the present invention is not limited thereto. The present invention may include a sensor element having any structure as long as the object of the present invention can be achieved, that is, the high water resistance of sensor element is maintained and high measurement accuracy is maintained even when the gas sensor is driven continuously for a long time.

In the gas sensor 100 of the above embodiment, as shown in FIG. 3, the inner layer 91 of the porous protective layer 90 in which the anterior region 91A and the main region 91M have respective uniform porosities is shown as an example, but the inner layer 91 is not limited thereto. The inner layer 91 can have any structure as long as the porosity ρA in the anterior region 91A of the inner layer 91 is lower than the porosity ρM in the main region 91M.

For example, in the anterior region 91A of the inner layer 91, a porosity may differ in the longitudinal direction of the element body 102. For example, in the anterior region 91A, a porosity may be increased in the longitudinal direction from the front end of the element body 102 toward the rear end. Alternatively, for example, a porosity may be decreased in the longitudinal direction from the front end toward the rear end.

For example, in the main region 91M of the inner layer 91, a porosity may be increased in the longitudinal direction from the front end side of the element body 102 toward the rear end. Alternatively, for example, in the longitudinal direction of the element body 102, porosities may be different from each other between in the electrode presence region 91E in which the outer pump electrode 23 exists and in the posterior region 91P following to the rear of the electrode presence region 91E. The porosity in the electrode presence region 91E may be higher or lower than the porosity in the posterior region 91P.

In the gas sensor 100 of the above embodiment, the porosity in the inner layer 91 on each of the surfaces other than the pump surface 102a is equivalent to the porosity in the main region 91M on the pump surface 102a, but is not limited thereto. The inner layer 91 may further have a region with a low porosity corresponding to that of the anterior region 91A on at least one surface of the surfaces (the heater surface 102b, the left surface 102c, the right surface 102d, and the front end surface 102e) other than the pump surface 102a.

In the cross section shown in FIG. 4, in at least one of the inner layers 91b, 91c, 91d on the respective surfaces other than the pump surface 102a, the inner layer 91 may further have a region with the low porosity corresponding to that of the anterior region 91A on the pump surface 102a. For example, in the cross section shown in FIG. 4, the inner layer 91 as a whole may be a region with the low porosity corresponding to that of the anterior region 91A on the pump surface 102a. That is, in the longitudinal direction of the element body 102, the entire area from the front end of the element body 102 to the front end of the outer pump electrode 23 (on the pump surface 102a, the heater surface 102b, the left surface 102c, and the right surface 102d) may be a region with the low porosity corresponding to that of the anterior region 91A on the pump surface 102a.

For example, in the inner layer 91, the inner layers 91c, 91d on the both of the side surfaces may be a region with the low porosity corresponding to that of the anterior region 91A on the pump surface 102a. Further, for example, in the inner layers 91c, 91d on the both of the side surfaces, the inner surfaces 91cu, 91du from the top end to the lower surface of the measurement-object gas flow cavity 15 (the buffer space 12) may be a region with the low porosity corresponding to that of the anterior region 91A on the pump surface 102a. It is possible to also reduce diffusion of the oxygen toward the front end direction through the inner layers 91c, 91d on the side surfaces, and thus the measurement accuracy can be maintained much higher.

Further, a porosity of the inner layer 91 may be stepwise or continuously increased in the longitudinal direction of the element body 102 (the base part 103) from the one end (the front end) in the longitudinal direction of the element body 102 (the base part 103) toward the other end (the rear end). In the inner layer 91 in the above embodiment, the porosity is increased in two steps, but the porosity may be stepwise increased (substantially stepwise increased) in three steps or more. The porosity may be continuously increased (substantially continuously increased).

In the gas sensor 100 of the above embodiment, the porous protective layer 90 is constituted from the inner layer 91 and the outer layer 92, but the porous protective layer 90 is not limited thereto. The porous protective layer 90 may have one or more intermediate layers between the inner layer 91 and the outer layer 92.

In the gas sensor 100 of the above embodiment, the porous protective layer 90 is constituted from two layers of the inner layer 91 and the outer layer 92 on each of the surfaces of the element body 102, but the porous protective layer 90 is not limited thereto. The porous protective layer 90 may be constituted from one layer on at least one surface of the surfaces (the heater surface 102b, the left surface 102c, the right surface 102d, and the front end surface 102e) other than the pump surface 102a of the element body 102.

In the gas sensor 100 of the above embodiment, the outer pump electrode 23 is positioned on the surface of the element body 102 and the inner layer 91 of the porous protective layer 90 is formed in contact with the outer pump electrode 23 on the surface of the element body 102. However, the present invention is not limited to this. For example, the element body 102 may be provided with a principal surface protective layer on the two principal surfaces (the pump surface 102a and the heater surface 102b). The principal surface protective layer is provided for the purpose of preventing foreign matter and poisoning substances from attaching to the principal surfaces (the pump surface 102a and the heater surface 102b) of the element body 102 and the outer pump electrode 23 on the pump surface 102a. The principal surface protective layer may be, for example, a porous layer formed of ceramics such as alumina. A porosity of the principal surface protective layer may be, for example, about 20% by volume or more and 40% by volume or less. A thickness of the principal surface protective layer may be, for example, about 5 μm to 30 μm.

Further, for example, the element body 102 may be further provided with a ground layer for forming the inner layer 91. The ground layer is provided for the purpose of further improving the adhesion between the element body 102 and the inner layer 91. When the ground layer is provided, the ground layer may be formed on at least the two principal surfaces (the pump surface 102a and the heater surface 102b) of the element body 102. The ground layer may be, for example, a porous layer formed of ceramics such as alumina. A porosity of the ground layer may be, for example, about 40% by volume or more. The porosity of the ground layer may be, for example, about 40% by volume or more and 60% by volume or less. A thickness of the ground layer may be, for example, about 20 μm to 60 μm.

In the above embodiment, the gas sensor 100 detects the NOx concentration in a measurement-object gas. However, the target gas to be measured is not limited to NOx. The sensor element of the gas sensor 100 may have a structure using the oxygen-ion-conductive solid electrolyte. For example, the target gas to be measured may be oxygen O₂ or an oxide gas other than NOx (e.g., carbon dioxide CO₂, water H₂O). Alternatively, the target gas to be measured may be a non-oxide gas such as ammonia NH₃.

In the gas sensor 100 of the above embodiment, as shown in FIG. 2, the sensor element 101 has a structure in which three internal cavities, the first internal cavity 20, the second internal cavity 40, and the third internal cavity 61 are provided and the inner main pump electrode 22, the auxiliary pump electrode 51, and the measurement electrode 44 are respectively disposed in these internal cavities. However, the structure of the sensor element 101 is not limited thereto. For example, the sensor element 101 may have a structure in which two internal cavities, the first internal cavity 20 and the second internal cavity 40 are provided, the inner main pump electrode 22 is disposed in the first internal cavity 20, and the auxiliary pump electrode 51 and the measurement electrode 44 are disposed in the second internal cavity 40. In this case, for example, a porous protective layer covering the measurement electrode 44 may be formed as a diffusion-rate limiting part between the auxiliary pump electrode 51 and the measurement electrode 44. Further, the number of the internal cavities may be one, or may be four or more.

In the gas sensor 100 of the above embodiment, the outer pump electrode 23 has three functions as an outer main pump electrode in the main pump cell 21, an outer auxiliary pump electrode in the auxiliary pump cell 50, and an outer measurement electrode in the measurement pump cell 41. However, the outer pump electrode 23 is not limited thereto. For example, the outer main pump electrode, the outer auxiliary pump electrode, and the outer measurement electrode may be formed as different electrodes. For example, any one or more of the outer main pump electrode, the outer auxiliary pump electrode, and the outer measurement electrode may be provided on the outer surface of the base part 103 separately from the outer pump electrode 23 so as to be in contact with a measurement-object gas. In this case, the anterior region means, in the longitudinal direction of the element body 102, a region from the front end of the element body 102 to a front end of an electrode disposed the most front end side among the outer main pump electrode, the outer auxiliary pump electrode, and the outer measurement electrode. Alternatively, the reference electrode 42 may also serve as any one or two of the outer main pump electrode, the outer auxiliary pump electrode, and the outer measurement electrode.

Each of the components of the element body 102 other than the above-described components, such as the measurement-object gas flow cavity 15 and the electrodes, can also be variously embodied in accordance with the kind of target gas to be measured, the intended use or use environment of the gas sensor and the like.

### [Production Method of Sensor Element]

Hereinbelow, an example of a production method of such a sensor element as described above will be described. In the production method of the sensor element 101, the element body 102 is first produced, and then the porous protective layer 90 is formed on the element body 102 to produce the sensor element 101.

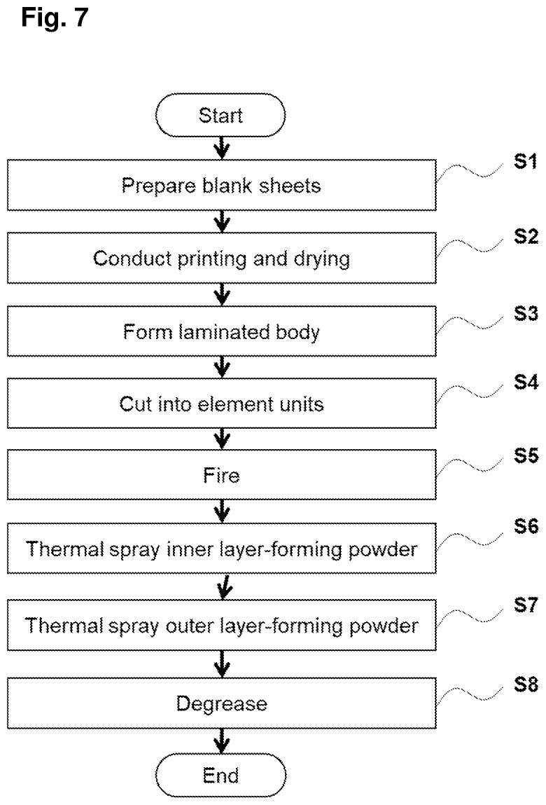

Hereinafter, description is made while taking the case of manufacturing the sensor element 101 composed of six layers shown in FIG. 2 as an example. FIG. 7 is a flowchart showing an example of the production method of the sensor element.

### (Production of Element Body)

First, a method for producing the element body 102 will be described. Six blank sheets are prepared (step S1). The blank sheets are green sheets containing an oxygen-ion-conductive solid electrolyte such as zirconia (ZrO₂) as a ceramic component. For manufacturing of the green sheets, a known molding method can be used. In each of the six green sheets, sheet holes or the like for use in positioning at the time of printing or stacking are formed in advance by a known method such as a punching process with a punching apparatus. These are referred to as blank sheets. In the blank sheet for use as the spacer layer 5, penetrating parts such as internal cavities are also formed in the same manner. Also in the remaining layers, necessary penetrating parts are formed in advance. The six blank sheets may all have the same thickness, or the thickness differs depending on the layer to be formed.

The blank sheets for use as six layers, namely, the first substrate layer 1, the second substrate layer 2, the third substrate layer 3, the first solid electrolyte layer 4, the spacer layer 5, and the second solid electrolyte layer 6 are subjected to printing of various patterns required for respective layers and drying treatment (step S2). For printing of a pattern, a known screen printing technique can be used. Also as the drying treatment, a known drying means can be used.

After completing the printing and drying of diverse patterns for each of the six blank sheets by repeating these steps, contact bonding treatment of stacking the six printed blank sheets in a predetermined order while positioning with the sheet holes and the like, and contact bonding at a predetermined temperature and pressure condition is conducted to form a laminated body (step S3). The contact bonding treatment is conducted by heating and pressurizing with a known laminator such as a hydraulic press. While the temperature, the pressure and the time of heating and pressurizing depend on the laminator being used, they may be appropriately determined to achieve excellent lamination.

The obtained laminated body includes a plurality of element bodies 102. The laminated body is cut into units of the element body 102 (step S4). The cut laminated body is fired at a predetermined firing temperature to obtain the element body 102 (step S5). The firing temperature may be such a temperature that the solid electrolyte forming the base part 103 of the sensor element 101 is sintered to become a dense product, and electrodes or the like maintains desired porosity. The firing is conducted, for example, at a firing temperature of about 1300 to 1500° C.

### (Production of Protective Layer)

Next, a method for forming the porous protective layer 90 (the inner layer 91 and the outer layer 92) on the element body 102 will be described. In this embodiment, the porous protective layer 90 is formed by plasma spraying.

First, a sprayed coating that should serve as the inner layer 91 is formed. That is, an inner layer-forming powder prepared in advance is thermally splayed onto a predetermined area on the element body 102 (step S6). Next, an outer layer-forming powder prepared in advance is thermally splayed onto the sprayed coating that should serve as the inner layer 91 of the element body 102 (step S7). Then, degreasing is conducted (step S8) to form the porous protective layer 90 (the inner layer 91 and the outer layer 92).

The inner layer-forming powder includes a raw material powder (in this embodiment, an alumina powder) composed of the material of the inner layer 91 and having a predetermined particle size distribution, and a pore forming material. Examples of the pore forming material that can be used include a xanthine derivative such as theobromine, an organic resin material such as an acrylic resin, and an inorganic material such as carbon. The inner layer-forming powder contains the alumina powder and an organic pore forming material at a ratio corresponding to a porosity of the inner layer 91 to be formed. In this embodiment, a first inner layer-forming powder corresponding to a porosity in the anterior region 91A of the inner layer 91 on the pump surface 102a, and a second inner layer-forming powder corresponding to a porosity in the main region 91M of the inner layer 91 on the pump surface 102a are prepared.

The inner layer-forming powder is thermally splayed onto an area where the inner layer 91 is to be formed on the surface of the element body 102 to form a sprayed coating (step S6). For thermal spraying, a known plasma spraying technique can be used. Specifically, the first inner layer-forming powder is thermally splayed onto an area where the anterior region 91A is to be formed in the area where the inner layer 91 is to be formed to form a sprayed coating. For example, the element body 102 other than the area where the anterior region 91A is to be formed may be covered (masked) by a baffle plate, and the first inner layer-forming powder may be thermally splayed onto the area where the anterior region 91A is to be formed. The second inner layer-forming powder is thermally splayed onto an area where the main region 91M is to be formed in the area where the inner layer 91 is to be formed to form a sprayed coating. In this embodiment, since the porosity in the inner layer 91 on each of the surfaces other than the pump surface 102a is equivalent to the porosity in the main region 91M, the second inner layer-forming powder is also thermally splayed onto areas where the inner layer 91 is to be formed on the respective surfaces to form sprayed coatings. For example, the sprayed coating that should serve as the anterior region 91A and an area where the inner layer 91 is not formed on the element body 102 may be covered (masked) by a baffle plate, and the second inner layer-forming powder may be thermally splayed onto the area that is not masked. It is to be noted that the order of forming these sprayed coatings may be appropriately determined. The sprayed coatings may be formed simultaneously on two or more areas.

Then, the outer layer 92 is formed. The outer layer-forming powder prepared in advance is thermally splayed onto a predetermined area on the sprayed coating that should serve as the inner layer 91 on the element body 102 (step S7) to form the outer layer 92.

The outer layer-forming powder includes a raw material powder (in this embodiment, an alumina powder) composed of the material of the outer layer 92 and having a predetermined particle size distribution. Unlike the case of the inner layer-forming powder, the outer layer-forming powder does not usually include the pore forming material.

The outer layer-forming powder is thermally splayed onto an area where the outer layer 92 is to be formed on the surface of the sprayed coating that should serve as the inner layer 91 on the element body 102 to form a sprayed coating (i.e., the outer layer 92) (step S7). For thermal spraying, a known plasma spraying technique can be used.

Finally, the formed sprayed coating that should serve as the inner layer 91 is subjected to heat treatment to be degreased (step 8). Degreasing makes the pore forming material in the sprayed coating disappear to form the inner layer 91 comprising a porous material. The step of degreasing is performed at a predetermined degreasing temperature. The degreasing temperature is not particularly limited as long as all pore forming material components in the sprayed coating of the inner layer 91 can disappear and the porous structure of the inner layer 91 can be maintained. The degreasing temperature may be lower than the firing temperature of the element body 102. For example, the sprayed coating is degreased at a degreasing temperature of about 400 to 900° C. In the step of degreasing, the sprayed coating of the outer layer 92 that does not contain the pore forming material is to be subjected to heat treatment at the same time.

In the above production method, thermal spraying of the inner layer-forming powder (step S6), thermal spraying of the outer layer-forming powder (step S7), and decreasing (step S8) are conducted in this order. However, thermal spraying of the inner layer-forming powder (step S6), and decreasing (step S8) may be conducted, and then thermal spraying of the outer layer-forming powder (step S7) may be conducted.

In the above production method, the inner layer 91 and the outer layer 92 are respectively formed by plasma spraying, but the production method is not limited to this. The inner layer 91 and the outer layer 92 may be respectively formed using other methods such as screen printing, dipping, and gel casting. Further, the inner layer 91 and the outer layer 92 may be formed using different methods from each other.

The obtained sensor element 101 is housed in a predetermined housing and incorporated in the gas sensor 100 in such a manner that the front end portion of the sensor element 101 comes into contact with a measurement-object gas and the rear end portion of the sensor element 101 comes into contact with a reference gas.

### EXAMPLES

Hereinafter, the case of actually manufacturing a sensor element and conducting a test is described as Examples. The present invention is not limited to the following Examples.

### 1. Production of Examples 1 to 2 and Comparative Examples 1 to 2

The sensor elements of Examples 1 to 2 and Comparative Examples 1 to 2 were produced in accordance with the above-described production method of the sensor element 101. Specifically, an element body 102 was produced which had a longitudinal length of 67.5 mm, a horizontal width of 4.25 mm, and a vertical thickness of 1.45 mm. Then, a porous protective layer 90 (an inner layer 91 and an outer layer 92) were formed by plasma spraying to produce the sensor element 101.

In each of the sensor elements of Examples 1 to 2 and Comparative Examples 1 to 2, a porosity difference Δρ(=ρA−ρM) between a porosity ρA in the anterior region 91A and a porosity ρM in the main region 91M was set to a value shown below. The porosity ρA in the anterior region 91A and the porosity ρM in the main region 91M were respectively obtained using the above-described determination method of the porosity.

In the sensor element of Example 1, the porosity difference Δρ was set to minus (−) 5%. The porosity ρA in the anterior region 91A was about 50%, and the porosity ρM in the main region 91M was about 55%.

In the sensor element of Example 2, the porosity difference Δρ was set to minus (−) 10%. The porosity ρA in the anterior region 91A was about 45%, and the porosity ρM in the main region 91M was about 55%.

In the sensor element of Comparative Example 1, the porosity difference Δρ was set to 0%. The porosity ρA in the anterior region 91A was about 50%, and the porosity ρM in the main region 91M was about 50%.

In the sensor element of Comparative Example 2, the porosity difference Δρ was set to 5%. The porosity ρA in the anterior region 91A was about 55%, and the porosity ρM in the main region 91M was about 50%.

In all of the sensor elements of Examples 1 to 2 and Comparative Examples 1 to 2, the length of the inner layer 91 in the longitudinal direction from the front end of the element body 102 was set to 10 mm and the thickness of the inner layer 91 was set to 500 μm. In all of the sensor elements, the porosity in the inner layer 91 on each of the surfaces other than the pump surface 102a was set to be equivalent to the porosity in the main region 91M.

In all of the sensor elements of Examples 1 to 2 and Comparative Examples 1 to 2, the length of the outer layer 92 in the longitudinal direction from the front end of the element body 102 was set to 10 mm and the thickness of the outer layer 92 was set to 200 μm. The porosity of the outer layer 92 was 25%.

### 2. Evaluation of Measurement Accuracy

The sensor elements of Examples 1 to 2 and Comparative Examples 1 to 2 were subjected to evaluation of measurement accuracy. The measurement accuracy during continuous drive was evaluated by using the pump current Ip0 that flows corresponding to O₂ concentration in a measurement-object gas. Specifically, initially, the heater 72 was energized, the temperature was set at 800° C., and the sensor element 101 was heated. In this state, the pump control at normal drive is performed in an air atmosphere. That is, the main pump cell 21, the auxiliary pump cell 50, the measurement pump cell 41, the oxygen-partial-pressure detection sensor cell 80 for main pump control, the oxygen-partial-pressure detection sensor cell 81 for auxiliary pump control, and the oxygen-partial-pressure detection sensor cell 82 for measurement pump control were actuated as described above. The oxygen concentration in the first internal cavity 20 was controlled so as to be maintained at a predetermined constant value, and the pump current Ip0 corresponding to oxygen concentration in a measurement-object gas (here, the air) flowed through the main pump cell 21. In this state, the sensor elements were continuously driven for 100 hours.

The pump current Ip0 (Ip0_{0H}) at the start time of normal drive and the pump current Ip0 (Ip0_{100H}) at the time after a lapse of 100 hours of continuous drive were respectively acquired. Here, “the start time of normal drive” means the point of time when the temperature of the sensor element and a current value of the pump current were stabilized. A rate of change (rate of change in O₂ signal) of the pump current Ip0 was calculated by the following formula.

Rate of change in O₂ signal (%)=(Ip0_{100H}/Ip0_{0H}−1)×100

Based on the calculated rate of change in O₂ signal, measurement accuracy of the O₂ concentration (accuracy of the O₂ signal) was evaluated according to the following criteria. The results are shown in Table 1.
A: Rate of change in O₂ signal is not more than ±5%
B: Rate of change in O₂ signal is more than ±5% and not more than ±10%
C: Rate of change in O₂ signal is more than ±10%

TABLE 1

| | Magnitude relation between | Porosity | Rate of |
|---|---|---|---|
| | porosity ρA of anterior region | difference | change in |
| | and porosity ρM of main region | (ρA − ρM) | O₂ signal |
| Example 1 | ρA < ρM | −5% | B |
| Example 2 | ρA << ρM | −10% | A |
| Comparative | ρA = ρM | 0% | C |
| Example 1 | | | |
| Comparative | ρA > ρM | 5% | C |
| Example 2 | | | |

As shown in Table 1, both of Examples 1 to 2 were confirmed to be able to maintain high accuracy of the O₂ signal compared with Comparative Examples 1 to 2 even after a lapse of 100 hours of continuous drive. It was also confirmed that the accuracy of the O₂ signal could be maintained higher when the porosity difference was large, that is, the porosity ρA in the anterior region 91A was further lower than the porosity ρM in the main region 91M.

As has been described above, according to the present invention, since the anterior region 91A of the inner layer 91 can suppress the oxygen pumped out from the measurement-object gas flow cavity 15 from introducing again into the measurement-object gas flow cavity 15 from the gas inlet 10 via the inner layer 91, high measurement accuracy can be maintained even when continuous drive is performed. Therefore, it is possible to provide the sensor element that has high water resistance and maintains high measurement accuracy.

### EXPLANATION OF REFERENCE SIGNS IN THE DRAWINGS

1: first substrate layer; 2: second substrate layer; 3: third substrate layer; 4: first solid electrolyte layer; 5: spacer layer; 6: second solid electrolyte layer; 10: gas inlet; 11: first diffusion-rate limiting part; 12: buffer space; 13: second diffusion-rate limiting part; 15: measurement-object gas flow cavity; 20: first internal cavity; 21: main pump cell; 22: inner main pump electrode; 22a: ceiling electrode portion (of the inner main pump electrode); 22b: bottom electrode portion (of the inner main pump electrode); 23: outer pump electrode; 24: variable power supply (of the main pump cell); 30: third diffusion-rate limiting part; 40: second internal cavity; 41: measurement pump cell; 42: reference electrode; 43: reference gas introduction space; 44: measurement electrode; 46: variable power supply (of the measurement pump cell); 48: air introduction layer; 50: auxiliary pump cell; 51: auxiliary pump electrode; 51a: ceiling electrode portion (of the auxiliary pump electrode); 51b: bottom electrode portion (of the auxiliary pump electrode); 52: variable power supply (of the auxiliary pump cell); 60: fourth diffusion-rate limiting part; 61: third internal cavity; 70: heater part; 71: heater electrode; 72: heater; 73: through hole; 74: heater insulating layer; 75: pressure relief vent; 76: heater lead; 80: oxygen-partial-pressure detection sensor cell for main pump control; 81: oxygen-partial-pressure detection sensor cell for auxiliary pump control; 82: oxygen-partial-pressure detection sensor cell for measurement pump control; 83: sensor cell; 90, 990: porous protective layer; 91, 991: inner layer; 92: outer layer; 100: gas sensor; 101: sensor element; 102: element body; and 103: base part.

What is claimed is:

1. A sensor element for detecting a target gas to be measured in a measurement-object gas, the sensor element comprising:
an element body that includes a base part in an elongated plate shape, including an oxygen-ion-conductive solid electrolyte layer, and a measurement-object gas flow cavity formed on a side of one end in a longitudinal direction of the base part; and
a porous protective layer that is formed from the one end in the longitudinal direction of the base part and covers a surface of a predetermined length in the longitudinal direction of the element body, wherein
the element body comprises: an intracavity electrode disposed in the measurement-object gas flow cavity; and an extracavity electrode that has a predetermined length in the longitudinal direction of the base part, is disposed on one principal surface of two principal surfaces of the element body from the one end with a predetermined distance, and corresponds to the intracavity electrode;
the protective layer comprises an inner layer covering the element body and an outer layer positioned outside the inner layer on at least the one principal surface on which the extracavity electrode exists; and
the protective layer has, on the one principal surface on which the extracavity electrode exists, a main region including an electrode presence region in which the extracavity electrode exists and a posterior region following to the electrode presence region; and an anterior region from the one end in the longitudinal direction of the base part to the electrode presence region, in the longitudinal direction of the base part; and wherein
a porosity in the anterior region of the inner layer is lower than a porosity in the main region of the inner layer, and
a porosity of the outer layer is lower than the porosity in the anterior region of the inner layer.

2. The sensor element according to claim 1, wherein the porosity in the anterior region of the inner layer is lower than the porosity in the main region of the inner layer by 5% by volume or more.

3. The sensor element according to claim 1, wherein the porosity in the anterior region of the inner layer is lower than the porosity in the main region of the inner layer by 10% by volume or more.

4. The sensor element according to claim 1, wherein the posterior region of the protective layer extends in the longitudinal direction of the base part to a position farther from the one end in the longitudinal direction of the base part than the measurement-object gas flow cavity.

5. The sensor element according to claim 1, wherein, on the one principal surface on which the extracavity electrode exists, a porosity of the inner layer is stepwise or continuously increased in the longitudinal direction of the base part from the one end in the longitudinal direction of the base part.
